(19) United States
(12) Patent Application Publication
(10) Pub. No.: US 2018/0275940 A1
(43) Pub. Date: Sep. 27, 2018

(54) PERSONALIZED DISPLAY SYSTEM AND METHOD FOR DYNAMICALLY DISPLAYING USER INFORMATION

(71) Applicant: WIPRO LIMITED, Bangalore (IN)

(72) Inventors: Vijay Kumar, Bangalore (IN); Thomas Chittakattu Ninan, Kannur (IN); Shagun Rai, Allahabad (IN)

(21) Appl. No.: 15/470,346

(22) Filed: Mar. 27, 2017

(51) Int. Cl. G06F 3/147; G06F 3/01; G06K 9/00

(52) U.S. Cl. CPC G06F 3/147; G06K 9/00255; G06K 9/00288; G06F 3/011

(57) ABSTRACT

The present disclosure relates to field of image processing. Accordingly, disclosed herein is a personalized display system for dynamically displaying user information. An electronic display unit associated with the personalized display system captures visual images of the user and the belongings of the user. The personalized display system receives the captured visual images, extracts user characteristics, and determines the identity of the user. Later, the information related to the identified user are displayed on the electronic display unit. Further, the electronic display unit may continuously monitor an availability status of the user to efficiently manage allocation or deallocation of a workplace and other resources to the users. In an embodiment, the personalized display system also performs customization of environment based on environmental preferences of the user, thereby enhancing overall efficiency and comfort level of the user.

### TECHNICAL FIELD

The present subject matter is related, in general to image processing, and more particularly, but not exclusively to a personalized display system and method for dynamically displaying user information.

### BACKGROUND

Presently, each sector of economy is becoming smart and is relying on technology, directly or indirectly, to accomplish its tasks and targets. Even work places or workstations that are assigned to staffs within an organization are not an exception to such transformation. Further, with the workstations becoming smart and futuristic, and staff becoming mobile, concept of fixed seating is being replaced by flexible seating. An advantage of the flexible seating is that, it allows a person to choose and occupy a workstation anywhere within the organization for a day or for a required duration of time in the day. However, the flexible seating concept leads to an issue of identification of the person who is occupying the workstation for the day.

### SUMMARY

Disclosed herein is a personalized display system for dynamically displaying user information. The personalized display system comprises an electronic display unit. The electronic display unit comprises a display interface and is associated with one or more image capturing devices to capture one or more visual images of the user and one or more objects associated with the user. Further, the personalized display system comprises a processor. The processor is associated with the electronic display unit. Furthermore, the personalized display system comprises a memory which is communicatively coupled to the processor. The memory stores processor-executable instructions, which, on execution, causes the processor to receive the one or more visual images from the one or more image capturing devices. Upon receiving the one or more visual images, the processor extracts at least one of one or more user characteristics and object properties from each of the one or more visual images. Further, the processor determines identity of the user by comparing the one or more user characteristics with one or more pre-stored user characteristics. Finally, the processor displays information related to the user on the display interface.

Further, the present disclosure discloses a method of dynamically displaying user information. The method comprises receiving, by a personalized display system, one or more visual images of the user and one or more objects associated with the user. The one or more visual images are captured by one or more image capturing devices associated with an electronic display unit. The electronic display unit is associated with the personalized display system. Upon receiving the one or more visual images, the method comprises extracting at least one of one or more user characteristics and object properties from each of the one or more visual images. Further, the method comprises determining identity of the user by comparing the one or more user characteristics with one or more pre-stored user characteristics. Finally, the method comprises displaying information related to the user on a display interface configured in the electronic display unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment in accordance with some embodiments of the present disclosure;

FIG. 2 shows a detailed block diagram illustrating a personalized display system for dynamically displaying user information in accordance with some embodiments of the present disclosure;

FIG. 3A and FIG. 3B illustrate working of an electronic display unit associated with the personalized display system in accordance with some embodiments of the present disclosure;

FIG. 4 shows a flowchart illustrating a method of dynamically displaying user information in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure discloses a personalized display system for dynamically displaying user information. The user information may be displayed on an electronic display unit. In an implementation, the electronic display unit may be configured with one or more image capturing devices such as, a depth camera, along with a display interface for efficiently capturing one or more visual images of the user and to display information related to the identified user on the display interface. For example, when the user occupies a workplace near the electronic display unit, the one or more image capturing devices would capture the visual images of the user and one or more belongings of the user. Later, one or more user characteristics may be extracted from the one or more visual images to identify the user by comparing the extracted user characteristics against pre-stored user characteristics. Upon identifying the user, the personalized display system may dynamically populate the information related to the user on the display interface of the electronic display unit.

In an embodiment, the personalized display system may continue to display the information related to the user on the display interface as long as the user is available. The availability of the user may be determined by checking if the user is in field of view of the one or more image capturing devices. Further, the availability of the user may be determined by comparing properties of the one or more objects associated with the user against one or more pre-stored object properties. Alternatively, the availability of the user may be confirmed by verifying attendance status of the user from a real-time attendance monitoring system.

Additionally, the personalized display system may be used for customizing various environmental parameters such as, Heat, ventilation, and air conditioning (HVAC) parameters, specific to the identified user based on preferences of the user.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

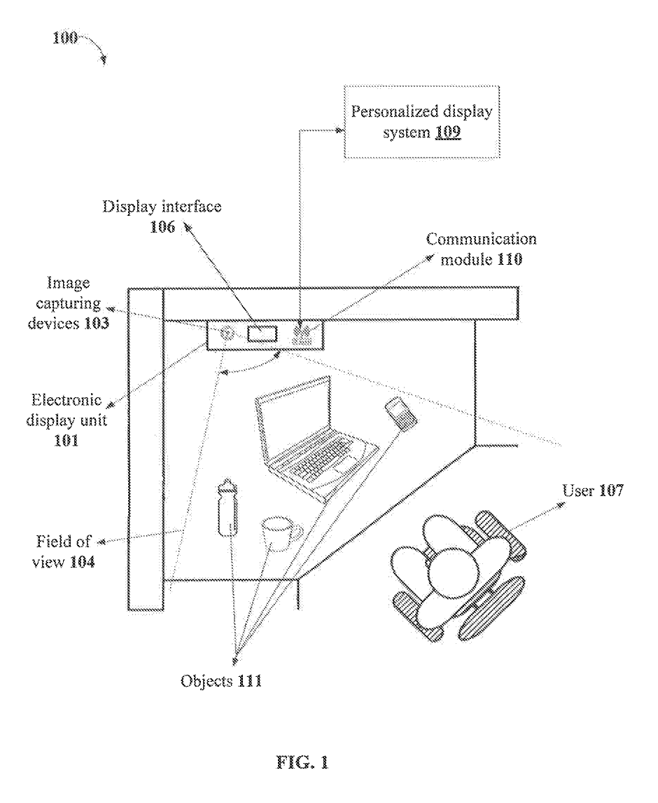

FIG. 1 shows an exemplary environment in accordance with some embodiments of the present disclosure.

Accordingly, environment 100 includes an electronic display unit 101 and a user 107. The electronic display unit 101 may include one or more image capturing devices 103, a display interface 106 and a communication module 110. The one or more image capturing devices 103 may capture one or more visual images of the user 107 and one or more objects 111 or belongings associated with the user 107. In an embodiment, the one or more image capturing devices 103 may be configured within the electronic display unit 101 and may include, without limiting to, a black and white image sensor, a color image sensor, a Red Green Blue (RGB) depth camera, and the like. Alternatively, the one or more image capturing devices 103 may be configured external to the electronic display unit 101. In another embodiment, the one or more image capturing devices 103 may include a video capturing unit, which would continuously monitor the user 107. In an embodiment, the communication module 110 may be used to transmit the one or more visual images to the personalized display system 109.

In an implementation, the electronic display unit 101 may be communicatively associated with a personalized display system 109. The electronic display unit 101 may transmit each of the one or more visual images to the personalized display system 109 through the communication module 110. Upon receiving the one or more visual images, the personalized display system 109 may extract one or more user characteristics and object properties from each of the one or more visual images for determining an identity of the user 107.

As an example, the one or more user characteristics that are extracted from the one or more visual images may include facial characteristics of the user 107, which in turn may be compared against pre-stored facial characteristics of the user 107 to identify the identity of the user 107. Further, the personalized display system 109 may analyze each of the one or more visual images to detect the one or more objects 111 associated with the user 107, such as cellphone of the user 107, a water flask or a coffee mug used by the user 107 and the like. Based on the analysis, the personalized display system 109 extracts one or more object properties, which are properties specific to the one or more objects 111 of the user 107, to confirm presence and/or availability of the user 107 within the field of view 104 of the one or more image capturing devices 103.

In an embodiment, once the identity of the user 107 is determined by the personalized display system 109, the personalized display system 109 may communicate with one or more data sources such as, a Lightweight Directory Access Protocol (LDAP) and an Enterprise Resource Planning (ERP) databases in the organization to which the user 107 belongs, to retrieve various information related to the user 107. Further, the personalized display system 109 transmits the information related to the user 107 to the electronic display unit 101 (also referred to as nameplate). The electronic display unit 101 displays the user information received from the personalized display system 109 through the display interface 106 configured in the electronic display unit 101.

In an embodiment, the electronic display unit 101 continues to display the information related to user 107 on the display interface 106 till the user 107 is available in region of the electronic display unit 101. In an implementation, the personalized display system 109 may determine an availability status 215 of the user 107 to control the displaying of the user information on the display interface 106. The availability status 215 may be a constraint such as of ‘available’ or ‘unavailable’, which indicates the presence and/or absence of the user 107 in the field of view 104 of the one or more image capturing devices 103. In an embodiment, the availability status 215 may be determined by comparing the one or more object properties with pre-stored properties of the objects 111. On the other hand, the personalized display system 109 may be linked to a real-time attendance monitoring system in the organization to access details related to attendance, appointments, and calendar events scheduled for the user 107, thereby determining when the availability of the user 107.

In some embodiments, the intended use of the personalized display system 109 is not limited to a workplace of an organization. Instead, the personalized display system may be configured to monitor, identify and display information related to users across various locations such as, hospitals, schools, public booths, and the like.

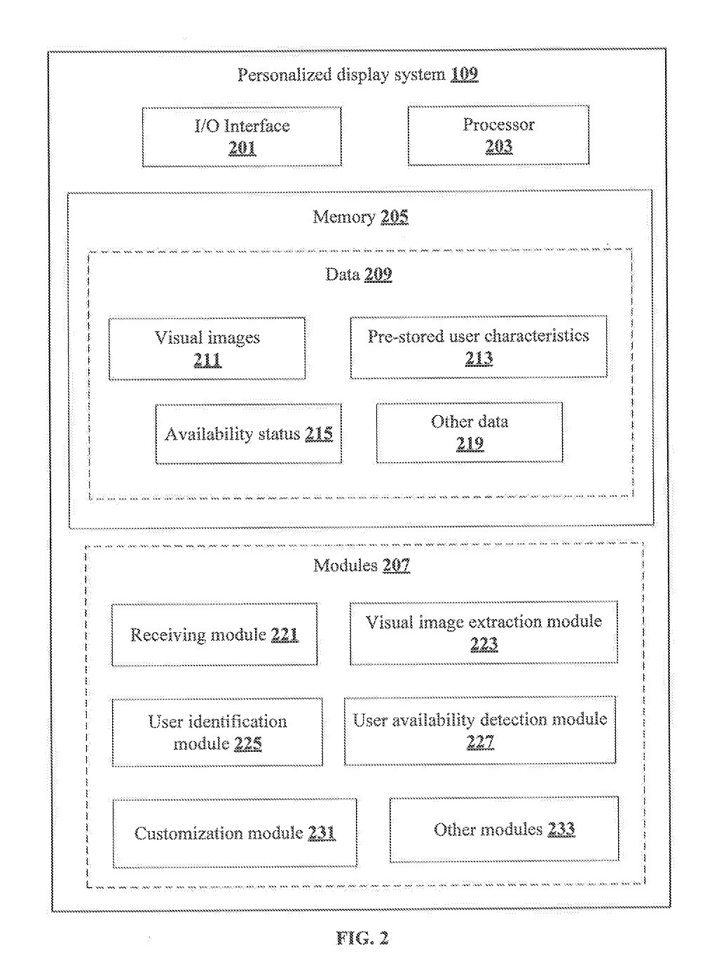

FIG. 2 shows a detailed block diagram illustrating a personalized display system 109 for dynamically displaying user information in accordance with some embodiments of the present disclosure.

The personalized display system 109 may include an I/O interface 201, a processor 203 and a memory 205. The I/O interface 201 may be responsible for communicating with the electronic display unit 101 to receive one or more visual images 211 of the user 107 and the objects 111, and to transmit the information related to the user 107 to the display interface 106. The memory 205 may be communicatively coupled to the processor 203. The processor 203 may be configured to perform one or more functions of the personalized display system 109 for dynamically displaying the user information. In one implementation, the personalized display system 109 may include data 209 and modules 207, which are used for performing various operations in accordance with the embodiments of the present disclosure. In an embodiment, the data 209 may be stored within the memory 205 and may include, without limiting to, the one or more visual images 211, pre-stored user characteristics 213, availability status 215, and other data 219.

In some embodiments, the data 209 may be stored within the memory 205 in the form of various data structures. Additionally, the data 209 may be organized using data models, such as relational or hierarchical data models. The other data 219 may store data, including temporary data and temporary files, generated by the modules 207 while dynamically displaying the user information on the electronic display unit 101.

In an embodiment, the one or more visual images 211 are captured by the one or more image capturing devices 103 configured within the electronic display unit 101. Suppose the user 107 has occupied a workplace. Here, the one or more visual images 211 captured by the one or more image capturing devices 103 would include a specific region of the workplace which falls within the field of view 104 of the one or more image capturing devices 103. In an embodiment, the one or more visual images 211 are captured recurrently and/or periodically and each of the one or more visual images 211 are processed by the personalized display system 109 to extract the one or more user characteristics and the object properties from each of the one or more visual images 211.

In an embodiment, the pre-stored user characteristics 213 may include user specific characteristics and behavioral attributes that are used by the personalized display system 109 to determine the identity of the user 107. As an example, the pre-stored user characteristics 213 of the user 107 may include, without limiting to, facial characteristics of the user 107, hand gestures/movements of the user 107, and the like. The pre-stored user characteristics 213 may be extracted from the one or more historical visual images 211 of the user 107 and are updated whenever a new user characteristic is identified.

In an embodiment, the availability status 215 of the user 107 may be determined based on presence of the user 107 and/or objects 111 in the field of view 104 of the one or more image capturing devices 103 or based on attendance status of the user 107. The presence of objects 111 may be determined by extracting one or more object properties from the one or more visual images 211 and then comparing the extracted object properties with pre-stored object properties related to the objects 111 of the user 107. As an example, the object properties may include, without limiting to, dimension of the object, color of the object, user-specific inscriptions on the objects 111 and the like. Further, the attendance status of the user 107 may be retrieved from a real-time attendance monitoring system. In an embodiment, the availability status 215 of the user 107 may be one of ‘available’ or ‘unavailable’.

In some embodiment, the data 209 may be processed by one or more modules 207 in the personalized display system 109. In one implementation, the one or more modules 207 may be stored as a part of the processor 203. In another implementation, the one or more modules 207 may be communicatively coupled to the processor 203 for performing one or more functions of the personalized display system 109. The modules 207 may include, without limiting to, a receiving module 221, a visual image extraction module 223, a user identification module 225, a user availability detection module 227, a customization module 231 and other modules 233.

As used herein, the term ‘module’ may refer to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 233 may be used to perform various miscellaneous functionalities of the personalized display system 109. It will be appreciated that such modules 207 may be represented as a single module or a combination of different modules.

In an embodiment, the receiving module 221 may be responsible for receiving the one or more visual images 211 of the user 107 and the one or more objects 111 associated with the user 107 from the electronic display unit 101.

In an embodiment, the visual image extraction module 223 may be responsible for extracting the one or more user characteristics and the one or more object properties from each of the one or more visual images 211 of the user 107 and the one or more objects 111 associated with the user 107. In an implementation, the visual image extraction module 223 may use any of the existing image processing and object detection techniques to identify regions which must be extracted from the one or more visual images 211. Additionally, the visual image extraction module 223 may be configured with a face recognition technique to clearly detect and extract the face of the user 107.

In an embodiment, the user identification module 225 may be responsible for detecting the identity of the user 107. The user identification module 225 may compare the one or more user characteristics extracted from the one or more visual images 211 with the one or more pre-stored user characteristics 213. As an example, the identity of the user 107 may be detecting by comparing the facial characteristics extracted from the one or more visual images 211 with pre-stored facial characteristics of one or more users. In an embodiment, once the user identification module 225 detects the identity of the user 107, the personalized display system 109 may retrieve the information related to the identified user 107 and may transmit the retrieved information to the electronic display unit 101 for displaying the information related to the user 107 on the display interface 106.

In an embodiment, the user availability detection module 227 may be responsible for determining the availability status 215 of the user 107 and to control the displaying of the user information on the display interface 106. As an example, the user availability detection module 227 may determine the availability status 215 by checking if the user 107 is present in the field of view 104 of the one or more image capturing devices 103. Alternatively, the availability status 215 may be determined by performing at least one of a comparison of the object properties with pre-stored object properties and verification of the attendance status of the user 107 from the real-time attendance monitoring system. In an embodiment, if the availability status 215 of the user 107 is determined to be ‘unavailable’, then the user availability detection module 227 may instruct the electronic display unit 101 to stop displaying the user information on the display interface 106.

In an embodiment, the customization module 231 may be responsible for customizing or modifying the environmental parameters such as temperature, air conditioning, ventilation, lighting, and the like, in surroundings of the user 107 as per the environmental preference of the user 107. The customization module 231 may be communicatively configured with the user identification module 225 and the user availability detection module 227 to identify the identity of the user 107 and to confirm whether the user 107 is available. As an example, if the range of temperature of the surroundings preferred by a user ‘A’ is between 21° Celsius and 24° Celsius, then the customization module 231 may automatically set (through an air-conditioner in the workplace of the user ‘A’) the temperature of the user surroundings to a value within the temperature range preferred by the user ‘A’, as soon as the user ‘A’ is identified is determined to be available. In an embodiment, once the availability status 215 of the user ‘A’ changes as ‘unavailable’, the customization module 231 may reset values of all the environmental parameters to predetermined default values.

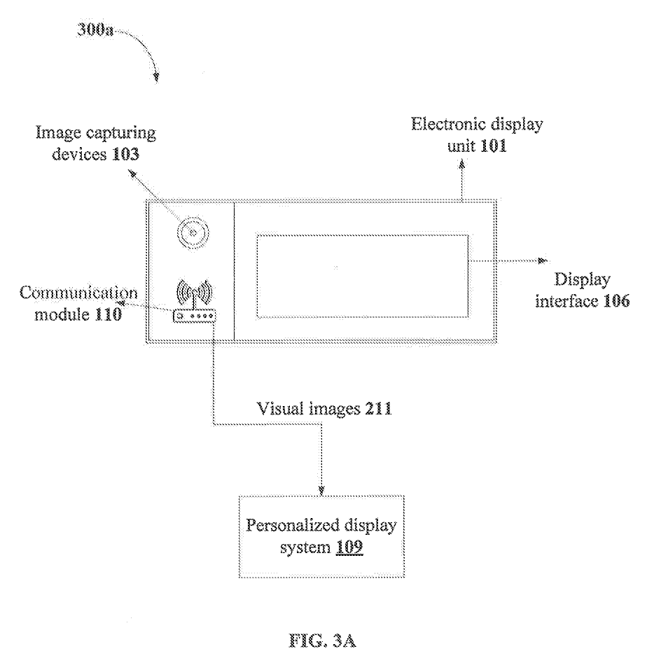

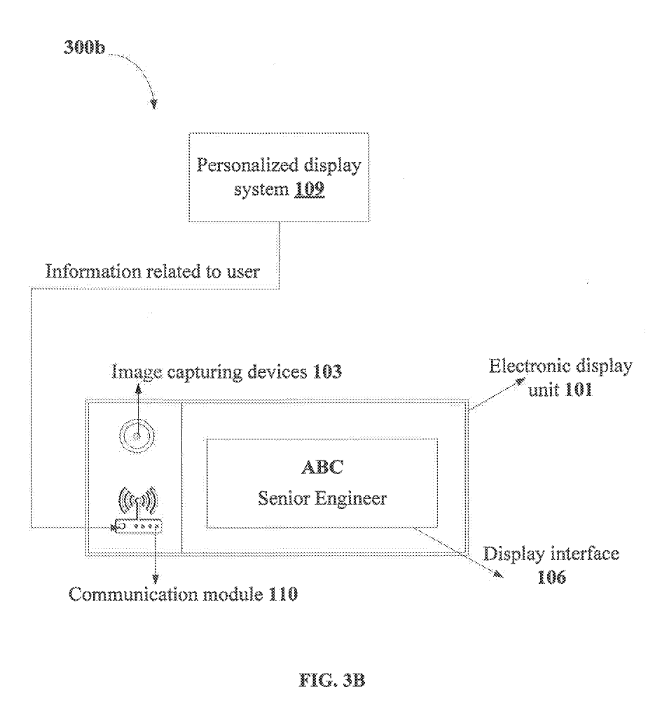

FIG. 3A and FIG. 3B illustrate working of an electronic display unit 101 associated with the personalized display system 109 in accordance with some embodiments of the present disclosure;

The environment 300a illustrates the electronic display unit 101 having the display interface 106, the one or more image capturing devices 103 and a communication module 110. In an embodiment, the electronic display unit 101 may be configured in a workplace of the user 107, such that, seating position and the work desk of the user 107 are within the field of view 104 of the one or more image capturing devices 103. The one or more image capturing devices 103 may capture one or more visual images 211 of the user 107 and the one or more objects 111/belongings associated with the user 107. At an initial point, the electronic display unit 101 may not display any information related to the user 107, since the identity of the user 107 is unknown. Hence, the display interface 106 may be left blank or turned off at the initial stage.

Therefore, to detect the identity of the user 107 and to display information related to the user 107, the electronic display unit 101 may transmit the one or more visual images 211 to the personalized display system 109 through the communication module 110. As an example, the communication module 110 may include, without limiting to, a wireless communication medium/interface such as Wi-Fi, Bluetooth and the like or a wired communication medium/interface such as Ethernet or any appropriate combinations thereof.

The personalized display system 109 processes each of the one or more visual images 211 to extract the user characteristics from each of the one or more visual images 211 using the visual image extraction module 223. Subsequently, the personalized display system 109, using the user identification module 225, may detect the identity of the user 107 by comparing the extracted user characteristics with the pre-stored user characteristics 213. Once the identity of the user 107 is detected, the personalized display system 109 may communicate with the one or more data sources, such as the ERP or the LDAP databases, in the organization of the user 107 to collect various information related to the user 107. Finally, the collected user information is transmitted to the electronic display unit 101 for displaying on the display interface 106.

Further, as illustrated in environment 300b in FIG. 3B, the electronic display unit 101 may receive the information related to the user 107 from the personalized display system 109 through the communication module 110. As an example, the information related to the user 107 may include name/identity of the user 107, such as user ‘ABC’, along with the role/designation of the user 107 such as, ‘Senior Engineer’. Then, the electronic display unit 101 displays the information received from the personalized display system 109 on the display interface 106. As an example, the display interface 106 may be one of a Cathode Ray Tube (CRT) based display, a Liquid Crystal Display (LCD), a Light Emitting Diode (LED) display or any other suitable form of display interface 106.

In some implementations, the display interface 106 may further include an input interface, such as a touchscreen interface, a button/switch based input interface or a biometric scanner, for receiving one or more manual inputs/instructions from the user 107. In an alternate embodiment, the biometric scanner in the display interface 106 may be used to instantly detect the identity of the user 107 when the user 107 uses the biometric scanner, thereby eliminating the requirement of extracting user characteristics from the one or more visual images 211.

In an implementation, there may be a plurality of electronic display units 101 associated with a plurality of workplaces within the organization. Each of the plurality of electronic display units 101 may be connected and monitored using the personalized display system 109. In an embodiment, suppose the user ‘ABC’ has occupied two workplaces at a given point of time. In this scenario, the personalized display system 109 would detect the presence and/or availability of the user 107 on both the workplaces based on either the presence of the user 107 himself in one of the workplace or based on the presence of one or more belongings of the user 107 in the workplaces. Now, upon detecting the availability of the user 107 on two workplaces, the personalized display system 109 may notify the user 107 to relinquish one of the workplace to avoid retention of multiple workplace and associated resources by the same user 107.

In an implementation, as soon as the identity of the user 107 is detected and the information related to the user 107 are displayed on the electronic display unit 101, the workplace and associated resources which are currently occupied by the user 107 are allocated to the user 107. The allocated workplace and the associated resources would be deallocated from the user 107 only when the availability status 215 of the user 107 is determined to be ‘unavailable’. Further, in scenarios where the user 107 has temporarily stepped out of the office for reasons such as appointments and meetings, the personalized display system 109 would still allocate the workplace and the associated resources to the user 107 if the one or more objects 111 associated with the user 107 are still present in the workplace. Alternatively, the personalized display system 109 may be configured to automatically deallocate the reserved workplace and the associated resources after waiting for a predetermined time. For example, the predetermined time of waiting may be 3 hours, such that, the personalized display system 109 deallocates the workplace from the user 107 if the user 107 is not present in the workplace for 3 hours, even if the one or more objects/belongings 111 of the user 107 are present in the workplace.

In some implementations, the electronic display unit 101 may be configured to display additional information about the user 107 such as, schedule of the user 107 in a day, expected time of arrival of the user 107 or any user-specific messages on the display interface 106. Displaying the aforesaid additional information at the regular workplace of the user 107 may help other users in the organization to realize the availability of the user 107 and availability of the user's workplace, thereby efficiently managing the resources within the organization.

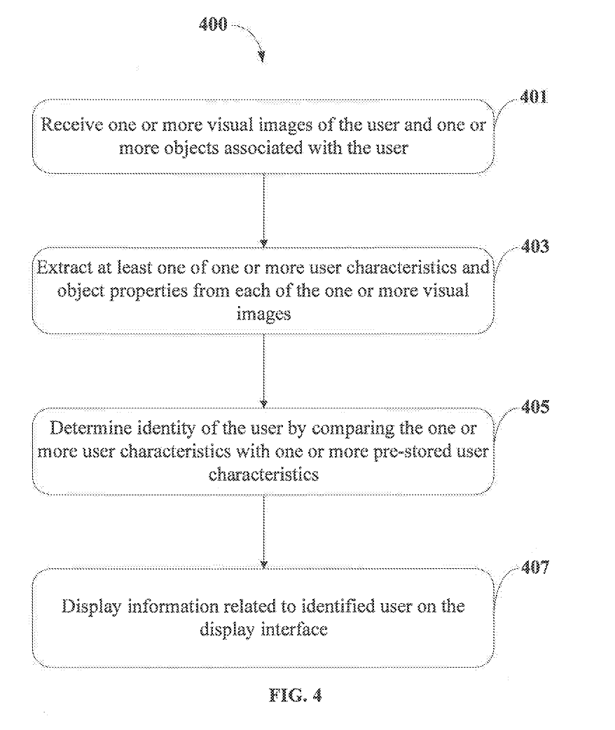

FIG. 4 shows a flowchart illustrating a method of dynamically displaying user information in accordance with some embodiments of the present disclosure.

As illustrated in FIG. 4, the method 400 includes one or more blocks for performing the method of dynamically displaying the user information using a personalized display system 109. The method 400 may be described in the general context of computer executable instructions. Generally, computer executable instructions can include routines, programs, objects, components, data structures, procedures, modules, and functions, which perform specific functions or implement abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the method 400 includes receiving, by the personalized display system 109, one or more visual images 211 of the user 107 and one or more objects 111 associated with the user 107. The one or more visual images 211 may be captured by one or more image capturing devices 103 associated with an electronic display unit 101. As an example, the one or more image capturing devices 103 may capture one or more visual images 211 at periodic intervals. In an embodiment, the electronic display unit 101 may be associated with the personalized display system 109.

At block 403, the method 400 includes extracting, by the personalized display system 109, at least one of one or more user characteristics and object properties from each of the one or more visual images 211. As an example, the one or more user characteristics may include facial characteristics of the user 107.

At block 405, the method 400 includes determining, by the personalized display system 109, identity of the user 107 by comparing the one or more user characteristics with one or more pre-stored user characteristics 213. As an example, the one or more pre-stored user characteristics 213 may be retrieved from a user characteristics database associated with the personalized display system 109 or from the LDAP or the ERP system of the organization.

At block 407, the method 400 includes displaying, by the personalized display system 109, information related to the user 107 on a display interface 106 configured in the electronic display unit 101. In an embodiment, the information related to the identified user 107 may be continuously displayed on the display interface 106 based on availability status 215 of the user 107. The availability status 215 may be determined by checking if the user 107 is present in the field of view 104 of the one or more image capturing devices 103. Alternatively, the availability status 215 may be determined by comparing the object properties with pre-stored object properties or by verifying attendance status of the user 107 from a real-time attendance monitoring system. In an embodiment, the information displayed on the display interface 106 may include at least one of name of the user 107, designation of the user 107, contact details of the user 107 and availability status 215 of the user 107.

Computer System

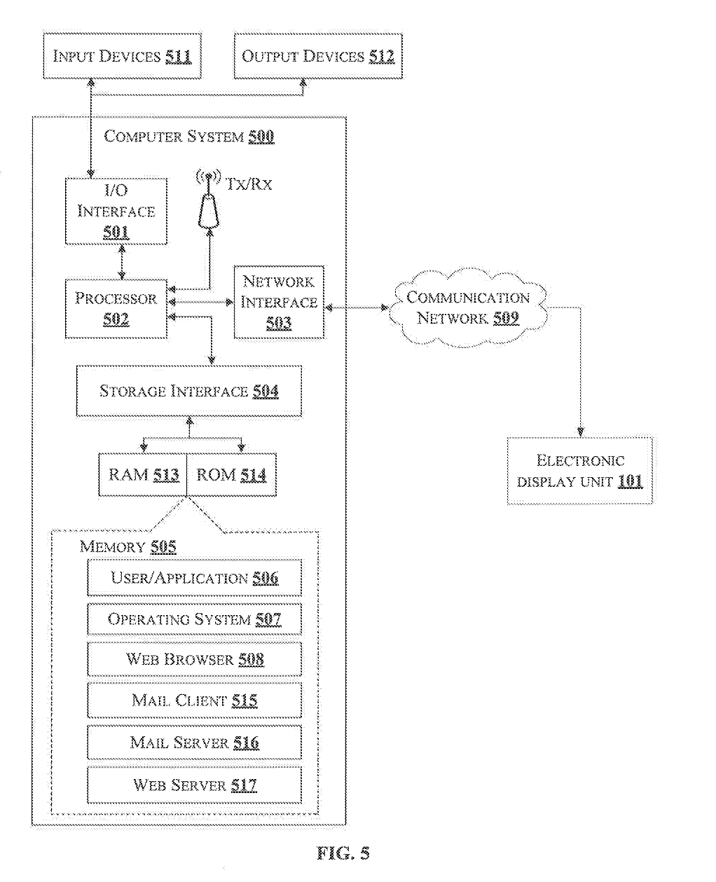

FIG. 5 illustrates a block diagram of an exemplary computer system 500 for implementing embodiments consistent with the present disclosure. In an embodiment, the computer system 500 may be the personalized display system 109 which may be used for dynamically displaying the user information. The computer system 500 may include a central processing unit (“CPU” or “processor”) 502. The processor 502 may include at least one data processor for executing program components for executing user- or system-generated business processes. A user may include a person, a customer, a person using a device such as those included in this invention, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA). High-Speed Packet Access (HSPA+), Global System For Mobile Communications (GSM), Long-Term Evolution (LTE) or the like), etc.

Using the I/O interface 501, the computer system 500 may communicate with one or more I/O devices (511 and 512). In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

Using the network interface 503 and the communication network 509, the computer system 500 may communicate with the electronic display unit 101 for receiving one or more visual images 211 captured by one or more image capturing devices 103 in the electronic display unit 101 and to transmit the user information to the electronic display unit 101. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web server 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### ADVANTAGES OF THE EMBODIMENT OF THE DISCLOSURE ARE ILLUSTRATED HEREIN

In an embodiment, the method of present disclosure dynamically displays information related to the user on an electronic display unit upon identifying the user.

In an embodiment, the present disclosure provides a method for dynamically allocating the workplace to the user upon identifying the presence of user in the workplace.

In an embodiment, the method of present disclosure can dynamically determine presence of the user in the workplace by detecting, recognizing, and tracking one or more belongings of the user.

In an embodiment, the method of present disclosure may dynamically deallocate the workplace allocated to the user upon determining that the user is not present and/or not available in the workplace, thereby enhancing resource management within an organization.

In an embodiment, the method of present disclosure may be enabled to fetch data from an attendance monitoring system, user calendar or other resources to dynamically allocate or deallocate the workplace to the user based on user's availability at the workplace.

In an embodiment, the present disclosure discloses a method for automatically customizing environmental conditions/parameters associated with the workplace as per environmental preference of the user.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Environment |
| 101 | Electronic display unit |
| 103 | Image capturing devices |
| 104 | Field of view |
| 106 | Display interface |
| 107 | User |
| 109 | Personalized display system |
| 110 | Communication module |
| 111 | Objects |
| 201 | I/O Interface |
| 203 | Processor |
| 205 | Memory |
| 207 | Modules |
| 209 | Data |
| 211 | Visual images |
| 213 | Pre-stored user characteristics |
| 215 | Availability status |
| 219 | Other data |
| 221 | Receiving module |
| 223 | Visual image extraction module |
| 225 | User identification module |
| 227 | User availability detection module |
| 231 | Customization module |
| 233 | Other modules |
| 500 | Computer system |
| 501 | I/O Interface of computer system |
| 502 | Processor of computer system |
| 503 | Network Interface |
| 504 | Storage Interface |
| 505 | Memory of computer system |
| 506 | User/Application of computer system |
| 507 | Operating system |
| 508 | Web interface |
| 509 | Communication network |
| 513 | RAM |
| 514 | ROM |
| 515 | Mail client |
| 516 | Mail server |
| 517 | Web server |

What is claimed is:

1. A personalized display system (109) for dynamically displaying user information, the personalized display system (109) comprising:
an electronic display unit (101) comprising a display interface (106) and associated with one or more image capturing devices (103) to capture one or more visual images (211) of the user (107) and one or more objects (111) associated with the user (107);
a processor (203) associated with the electronic display unit (101); and
a memory (205) communicatively coupled to the processor (203), wherein the memory (205) stores processor-executable instructions, which, on execution, causes the processor (203) to:
receive the one or more visual images (211) from the one or more image capturing devices (103);
extract at least one of one or more user characteristics and object properties from each of the one or more visual images (211);
determine identity of the user (107) by comparing the one or more user characteristics with one or more pre-stored user characteristics (213); and
display information related to identified user (107) on the display interface (106).

2. The personalized display system (109) as claimed in claim 1, wherein the processor (203) continues to display the information related to the identified user (107) based on availability status (215) of the user (107).

3. The personalized display system (109) as claimed in claim 2, wherein the processor (203) determines the availability status (215) by performing at least one of:
checking if the user (107) is in a field of view (104) of one or more image capturing devices (103);
comparing object properties with pre-stored object properties; and
verifying attendance status of the user (107) from a real-time attendance monitoring system.

4. The personalized display system (109) as claimed in claim 1, wherein the one or more visual images (211) are captured at periodic intervals.

5. The personalized display system (109) as claimed in claim 1, wherein the one or more user characteristics comprises facial characteristics of the user (107).

6. The personalized display system (109) as claimed in claim 1, wherein the information displayed on the display interface (106) comprises at least one of name of the user (107), designation of the user (107), contact details of the user (107) and availability status (215) of the user (107).

7. The personalized display system (109) as claimed in claim 1, wherein the processor (203) modifies one or more environmental properties based on environmental preferences of the user (107).

8. A method of dynamically displaying user information, the method comprising:
receiving, by a personalized display system (109), one or more visual images (211) of the user (107) and one or more objects (111) associated with the user (107), wherein the one or more visual images (211) are captured by one or more image capturing devices (103) associated with an electronic display unit (101), wherein the electronic display unit (101) is associated with the personalized display system (109);
extracting, by the personalized display system (109), at least one of one or more user characteristics and object properties from each of the one or more visual images (211);
determining, by the personalized display system (109), identity of the user (107) by comparing the one or more user characteristics with one or more pre-stored user characteristics (213); and
displaying, by the personalized display system (109), information related to identified user (107) on the display interface (106).

9. The method as claimed in claim 8, wherein the information related to the identified user (107) is continuously displayed on the display interface (106) based on availability status (215) of the user (107).

10. The method as claimed in claim 9, wherein the availability status (215) of the user (107) is determined by performing at least one of:
checking if the user (107) is in the field of view (104) of one or more image capturing devices (103);
comparing, by a personalized display system (109), object properties with pre-stored object properties; and
verifying attendance status of the user (107) from a real-time attendance monitoring system.

11. The method as claimed in claim 8, wherein the one or more visual images (211) are captured at periodic intervals.

12. The method as claimed in claim 8, wherein the one or more user characteristics comprises facial characteristics of the user (107).

13. The method as claimed in claim 8, wherein the information displayed on the display interface (106) comprises at least one of name of the user (107), designation of the user (107), contact details of the user (107) and availability status (215) of the user (107).

14. The method as claimed in claim 8 further comprising modifying one or more environmental properties based on environmental preferences of the user (107).
